(19) United States
(12) Patent Application Publication
(10) Pub. No.: US 2009/0090521 A1
(43) Pub. Date: Apr. 9, 2009

(54) Hydraulic disc/harrow apparatus, system and method for using the same

(75) Inventor: John P. Moyna, Elkader, IA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/289,665

(22) Filed: Oct. 31, 2008

Related U.S. Application Data
(62) Division of application No. 09/918,401, filed on Jul. 30, 2001.

(51) Int. Cl. A01B 79/00; A01B 63/10; A01B 63/32

(52) U.S. Cl. 172/1; 172/7; 172/318

(57) ABSTRACT

A method for dividing soil is disclosed. The method includes towing a frame via a hitch at a first end of the frame. The method also includes supporting the frame on the soil via an axle extending transversely of the frame, the axle connected to the frame between the first end of the frame and a second end of the frame. The method further includes dividing the soil with a plurality of rotatable discs attached to the frame between the frame and the soil, a first portion of the plurality of discs located between the first end of the frame and the axle, and a second portion of the plurality of discs located between the axle and the second end of the frame, wherein the first portion is aligned non-parallel with respect to the second portion. The method further includes moving the frame relative to the hitch to pivot about the axle.

This a division of U.S. application Ser. No. 09/918,401, filed Jul. 30, 2001, the entire contents of which are hereby incorporated by reference.

### BACKGROUND

The present invention generally relates to an apparatus having a frame with wheels and a plurality of discs attached to the frame and a method for using the same. More specifically, the present invention relates to an apparatus having dual hydraulic cylinders such that the frame may adjust during use of the apparatus. Moreover, the present invention provides an apparatus and a method that provides lubrication to bearings and/or wheels of the apparatus. Further, the apparatus of the present invention may be attached to a tractor by a single individual.

It is, of course, generally known to provide a harrow or disc that is pulled behind, for example, a tractor. The harrow is generally used to lift and/or divide compacted soil or dirt or mud from the ground. Often, a harrow is used, for example, at a construction site or on a farm to raise or lift the soil to speed the drying of the soil in preparation for construction or for cultivation purposes, such as plants, for example, respectively.

Known harrows are generally pivotally secured to the tractor and have discs secured to a frame of the harrow. A bearing assembly is typically positioned between the frame to permit the discs to rotate at the same time that the discs penetrate the soil and turn over the soil. In operation, the discs penetrate the ground and turn over the soil to allow for aeration of top layers of the soil. Depending on the size of the disc, various depths of soil may be turned over. Depth of penetration of the discs into the soil is also variable based on angles and/or pressures of the discs as the discs are pulled over the soil.

To adjust the angles of the penetration of the discs into the soil, currently, an operator of the tractor, truck or the like that is pulling the harrow must stop the tractor and manually adjust the height and/or the angles at which the discs penetrate the soil. This typically is effected by manually adjusting a screw that shifts the frame on which the discs are rotatably mounted. This process to adjust the discs is both difficult and time-consuming.

Another problem associated with harrows includes requiring more than one person to physically attach the harrow to a tractor. Further, maintaining the bearings and/or wheels in a clean and lubricated state is difficult with currently available harrows.

A need, therefore, exists for a method and an apparatus that adjusts to accommodate uneven terrain, connects to a tractor by a single individual and maintains the bearings and/or tires in a lubricated state.

### SUMMARY

The present invention provides an apparatus having an assembly such that the bearings and wheels may remain lubricated and the frame may adjust vertically during use thereof. Further, the apparatus of the present invention may be attached to a tractor by a single individual. Further, a method for using the apparatus of the present invention is provided.

To this end, in an embodiment of the present invention, an apparatus for separating soil is provided. The apparatus has a frame, a cylinder associated with the frame and a plurality of discs attached to the frame. The cylinder moves the frame. The apparatus has a controller associated with the cylinder. The controller is remote from the frame and controls movement of the frame.

In an embodiment, the apparatus has a front cylinder on the frame.

In an embodiment, the apparatus has a pillar associated with the frame and a column inside the pillar. The pillar may have a liner attached to an inside of the pillar of the frame. The pillar may have plates inside the pillar supporting the column.

In an embodiment, the apparatus has a hitch having a length defined between an end and a connector wherein the end of the hitch is attachable to the frame.

In an embodiment, the connector of the apparatus for separating soil rotates 360 degrees.

In an embodiment, the apparatus has tires supporting the frame. The tires have a plug in each of the tires of the frame.

In another embodiment of the present invention, a method for dividing soil is provided. The method is comprised of the steps of: providing a frame; providing a cylinder associated with the frame; connecting the frame to a tractor; moving the frame by remotely controlling movement of the cylinder; and pulling the frame over the soil.

In an embodiment, the method for separating soil further comprises of the step of providing a plurality of discs attached to the frame.

In an embodiment, the method for separating soil further comprises of the step of controlling elevation of the frame by adjusting the cylinder.

In an embodiment, the method for separating soil further comprises of the step of adjusting an angle of the frame with the soil by adjusting the cylinder.

In an embodiment, the method for separating soil further comprises of the step of self-adjusting the cylinder of the frame for controlling the angle of the frame with the soil.

In another embodiment of the present invention, an apparatus for separating soil is provided. The apparatus has a frame, a plurality of discs attached to the frame, a pillar associated with the frame and a column inside the pillar. The pillar has a liner attached to an inside of the pillar of the frame. The plates associated with the pillar support the column.

In an embodiment, the apparatus has a cylinder associated with the frame wherein the cylinder moves the pillar and the frame relative to the inside column.

In an embodiment, the apparatus has a front cylinder on the frame wherein the front cylinder moves to adjust the angle of the frame relative to the soil.

In an embodiment, the apparatus has a hitch having a length defined between an end and a connector wherein the end of the hitch is attachable to the frame.

In an embodiment, the connector of the apparatus for separating soil rotates 360 degrees.

In an embodiment, the apparatus for separating soil has tires supporting the frame.

It is, therefore, an advantage of the present invention to provide an apparatus and a method for attaching the apparatus to a tractor by a single individual.

Another advantage of the present invention is to provide an apparatus and a method for adjusting the apparatus for uneven terrain by a single operator.

Yet another advantage of the present invention is to provide an apparatus and a method for using the same wherein discs of the apparatus may be adjusted during use.

A still further advantage of the present invention is to provide an apparatus and a method that provides adjustment of the apparatus for uneven terrain by a remote controller.

Moreover, an advantage of the present invention is to provide an apparatus and a method for automatic adjustment of the apparatus for uneven terrain by a hydraulic cylinder.

Yet another advantage of the present invention is to provide an apparatus and a method for automatically and continuously lubricating bearings with little maintenance.

Another advantage of the present invention is to provide an apparatus and a method for automatically and continuously lubricating wheels with little maintenance.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a hydraulic disc/harrow apparatus in an embodiment of the present invention.

FIG. 2 illustrates a perspective view of an upper frame of the hydraulic disc/harrow apparatus in an embodiment of the present invention.

FIG. 2A illustrates a cross-sectional view taken generally along lines A-A of FIG. 2 of a pillar of the hydraulic disc/harrow apparatus in an embodiment of the present invention.

FIG. 2B illustrates a cross-sectional view taken along lines B-B of FIG. 2 of a pillar of the hydraulic disc/harrow apparatus in an embodiment of the present invention.

FIG. 3 illustrates a perspective view of a hydraulic piston of the hydraulic disc/harrow apparatus in an embodiment of the present invention.

FIG. 4 illustrates a perspective view of a connector in an embodiment of the present invention.

FIG. 5 illustrates a wheel of the hydraulic disc/harrow apparatus in an embodiment of the present invention.

### DETAILED DESCRIPTION

The present invention generally provides an apparatus and a method having dual hydraulic cylinders that may allow a frame of the apparatus to be remotely adjusted during use. Further, the apparatus may have bearings and wheels that may remain lubricated. Further, the present invention provides an apparatus and a method for attaching the apparatus to a tractor, for example, by an individual.

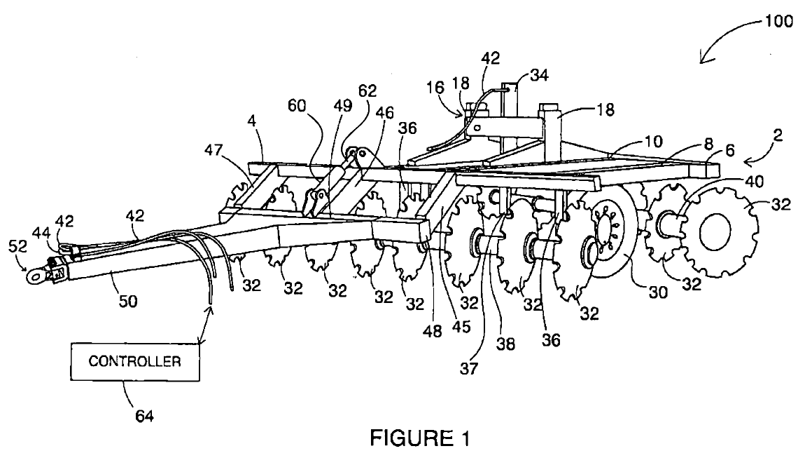

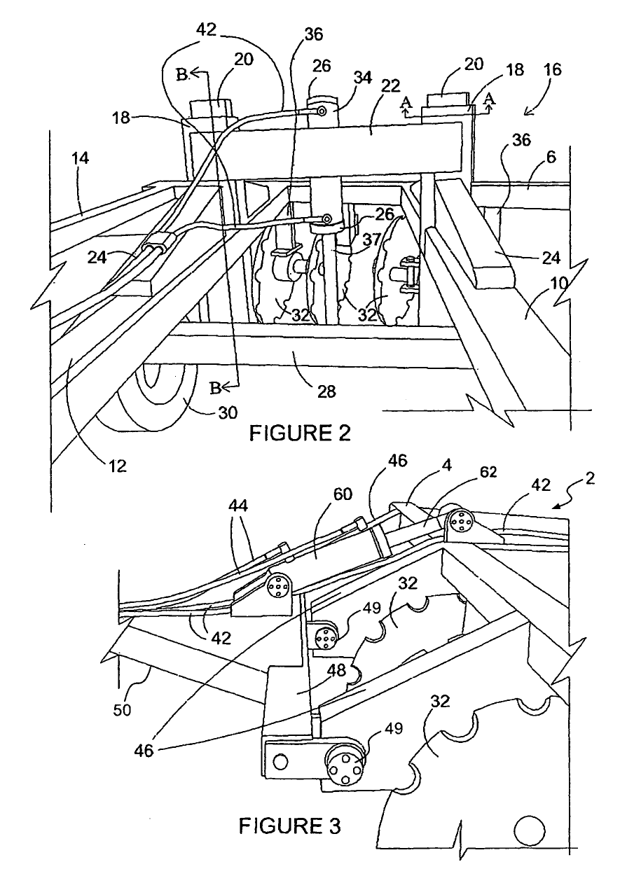

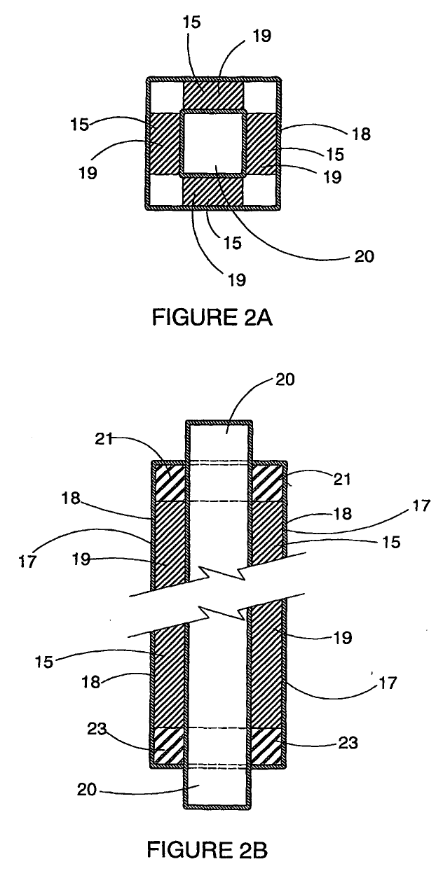

Referring now to the drawings wherein like numerals refer to like parts, FIG. 1 illustrates an apparatus 100 in an embodiment of the present invention. The apparatus 100 may have a frame 2 having a first bar 4 and a second bar 6. Arms 45, 46, 47 may extend outward and downward from the first bar 4 of the frame 2. The arms 45, 46, 47 may attach to a base bar 48 of a hitch 50 via pivots 49 (FIG. 2). The hitch 50 may have a length defined by the base bar 48 and a connector 52.

The first bar 4 and the second bar 6 may be connected by a first cross member 8, a second cross member 10, a third cross member 12 and/or a fourth cross member 14. The first cross member 8, the second cross member 10, the third cross member 12 and the fourth cross member 14 may each define a length between the first bar 4 and the second bar 6. Preferably, the length of the fourth cross member 14 is greater than the length defined by the third cross member 12. Further, preferably, the length of the third cross member 12 is greater than the length defined by the second cross member 10. Further still, preferably, the second cross member 10 is greater than the length defined by the first cross member 8. The preferred configuration of the fourth cross member 14 having a length greater than the length of the third cross member 12, having a length greater than the second cross member 10, having a length greater than the first cross member 8 defines a frame 2 configured such that the first bar 4 and the second bar 6 are non-parallel.

The first bar 4 and the second bar 6 may have legs 36 depending from the first bar 4 and the second bar 6. The legs 36 depending from the first bar 4 support a first disc axle 38. The legs 36 depending from the second bar 6 support a second disc axle 40. The first disc axle 38 and the second disc axle 40 support a plurality of discs 32.

Accordingly, in a preferred embodiment, the legs 36 depending from the first bar 4 are not parallel to the legs 36 depending from the second bar 6. Therefore, the first disc axle 38 is not parallel to the second disc axle 40. Thus, the discs 32 attached to the first disc axle 38 are not parallel to the disc attached to the second disc axle 40. The discs 32 attached to the first disc axle 38 form an angle with the discs 32 attached to the second disc axle 40.

When the apparatus 100 is in use, the frame 2 is pulled forward and the discs 32 of the frame 2 act as a soil breaking means. As the frame 2 is pulled forward, the discs 32 penetrate the ground and turn over the soil allowing for aeration of the soil.

An upper frame 16 may be mounted on the second cross member 10 and the third cross member 12 such that the upper frame 16 may be substantially centered on the frame 2. Referring now to FIG. 2, the upper frame 16 may have pillars 18 attached by a bar 22. As illustrated, the pillars 18 have substantially square cross-sections, however, other shapes may be implemented, such as a rectangular cross-section, circular cross-section or an oval-shaped cross-section or the like. The pillars 18 may be secured substantially perpendicular to the second cross member 10 and the third cross member 12.

The pillars 18 may each have a base 24 attached to the upper frame 16. Further, the pillars 18 may each house an inner column 20. The inner column 20 may extend downward, through the upper frame 16 and the frame 2, to a wheel axle 28. A liner 19, preferably plastic, may cover a length of the inside of each of the pillars 18 (as shown in FIG. 2A). The liner 19 preferably has a one-half inch thickness. The liner 19 may be constructed from, for example, four plastic pieces 15 that substantially or at least partially cover each interior side 17 of the pillars 18. In the preferred embodiment, the plastic pieces 15 may be retained at the top and bottom of the pillars 18 by a top plate 21 and a bottom plate 23, respectively (as shown in FIG. 2B).

A piston and cylinder assembly 34, 37 may have its cylinder attached to the center of the bar 22 and to the wheel axle 28. Preferably, the assembly 34, 37 is mounted vertically with respect to the frame 2 and the wheel axle 28. The assembly may include a piston rod 37 attached by end plates 26 to the inside of the cylinder 34. The piston rod 37 may raise and/or lower the frame 2 as well as the upper frame 16 relative to the wheel axle 28. The pillars 18 of the upper frame 16 may move relative to the inner columns 20. The liner 19 inside the pillars 18 may provide a smoother surface and thus less friction for the inner columns 20 to move relative to the pillars 18 when the piston rod 37 raises and lowers the frame 2 as well as the upper frame 16.

The piston rod 37 may be actuated by a controller 64 as generally illustrated in FIG. 1. Preferably, the controller 64 is located inside a tractor, truck or other like vehicle having the ability to pull the apparatus 100 across the terrain. Accordingly, an operator of the tractor may vertically adjust the apparatus 100 using the controller 64 and its associated functions by moving the assembly 34, 37 without having to exit the tractor. Preferably, the assembly 34, 37 may raise or lower the frame 2 of the apparatus 100 by two feet. The piston rod 37 may be actuated by the controller 64 controlling fluids to and from the piston and cylinder assembly 34, 37 via conduits 42.

Referring now to FIG. 3, a front hydraulic piston and cylinder assembly 60, 62 may be provided with a hydraulic piston rod 62 on one of the arms 45, 46, 47. The front assembly 60, 62 with its hydraulic piston rod 62 may be controlled remotely by the controller 64 (as generally shown and described with reference to FIG. 1), or alternatively, may be set to automatically adjust. Setting the hydraulic piston and cylinder assembly 60, 62 to automatically adjust may allow the hydraulic piston rod 62 to “float” thereby acting much like a shock absorber and responding directly to the changes in terrain without control of the depth and/or angle of penetration of the discs 32 by an operator via the controller 64 of the apparatus 100.

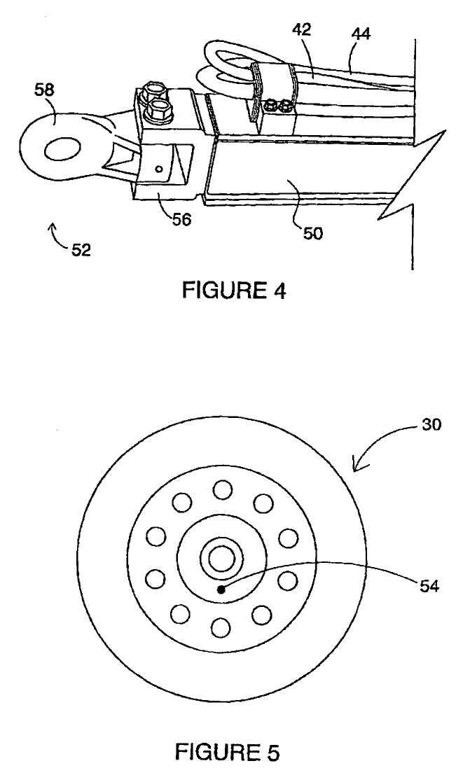

Referring now to FIG. 4, the connector 52 may have a base 56 and a ring 58. The ring 58 may be attached to a tractor (not shown) wherein the tractor may pull the apparatus over the terrain. The connector 52, having the base 56 and the ring 58, may spin in a clockwise or counter-clockwise direction. The spinning capability of the connector 52 may allow for the connector to be attached to a tractor by an individual without the assistance of another individual.

Referring again to FIGS. 1 and 2, a wheel 30 may be attached to the wheel axis 28 on either end of the wheel axis 28. The wheels 30 may support the frame 2, the upper frame 16 and the discs 32. As shown in FIG. 5, the wheels 30 may be maintained in an oil bath. The oil bath may provide constant lubrication. Lubrication of the wheels 30 may be provided directly by removing a screw plug 54 (shown in the “six o'clock” position in FIG. 5) on each of the wheels 30 and filling a receptacle with oil until, preferably, the receptacle is half full. To this end, the wheel 30 should be rotated such that the screw plug 54 is in the “nine o'clock” position or the “three o'clock” position. The oil may be added by removing the screw plug 54 and adding oil through the opening provided by removal of the screw plug 54. The opening provides access to a receptacle within the wheel 30 providing an oil bath, i.e., constant, maintenance free lubrication for each of the wheels 30. Accordingly, the oil bath provides for low maintenance lubrication of the wheels 30 as the wheels may remain constantly lubricated or lubricated at least for longer periods of time. Such lubrication saves time, as an operator may stop less frequently to adjust and/or maintain the apparatus 100.

Similar to the wheels 30, a bearing assembly may provide bearings (not shown) with an oil bath (not shown) which may provide constant lubrication to the bearings. The bearing assembly (not shown) may be positioned between the frame 2 and the discs 32 to permit the discs 32 to rotate at the same time they penetrate soil and turn over the soil.

### INDUSTRIAL APPLICABILITY

The frame 2 may be moved relative to the hitch 50 so as to pivot about the wheel axle 28 via a front hydraulic piston and cylinder assembly 60, 62. The front assembly 60, 62 with its hydraulic piston rod 62 may be controlled remotely by the controller 64, or alternatively, may be set to automatically adjust. Setting the hydraulic piston and cylinder assembly 60, 62 to automatically adjust may allow the hydraulic piston rod 62 to float and act much like a shock absorber and respond directly to the changes in terrain without control of the depth and/or angle of penetration of the discs 32 by an operator via the controller 64 of the apparatus 100. Accordingly, the apparatus 100 may be pivoted about the wheel axle 28 for uneven terrain remotely via the controller 64, or it may be set to adjust automatically in response to changes in terrain.

It should be understood that various changes and modifications to the presently preferred embodiments described herein will be apparent to those skilled in the art. Such changes and modifications may be made without departing from the spirit and scope of the present invention and without diminishing its attendant advantages.

What is claimed is:

1. A method for dividing soil, the method comprising:
providing a frame having a first bar and a second bar, wherein the first bar is located opposite to the second bar, wherein the frame has a first cross member and a second cross member connecting the first bar to the second bar, wherein the first cross member has a first length, wherein the second cross member has a second length, wherein the first length of the first cross member is greater than the second length of the second cross member;
attaching an axle to the frame;
providing a cylinder connected to the frame;
connecting the frame to a vehicle;
moving the frame by remotely controlling movement of the cylinder, wherein movement of the cylinder moves the frame with respect to the soil, wherein the frame pivots at the axle; and
pulling the frame over the soil.

2. The method of claim 1 further comprising:
providing a plurality of discs attached to the frame.

3. The method of claim 1 further comprising:
controlling elevation of the frame by adjusting the cylinder.

4. The method of claim 1 further comprising:
adjusting an angle of the frame with respect to the soil by adjusting the cylinder.

5. The method of claim 1 further comprising:
self-adjusting the cylinder of the frame for controlling the angle of the frame with respect to the soil.

6. A method for dividing soil, comprising:
towing a frame via a hitch at a first end of the frame,
supporting the frame on the soil via an axle extending transversely of the frame, the axle connected to the frame between the first end of the frame and a second end of the frame;
dividing the soil with a plurality of rotatable discs attached to the frame between the frame and the soil, a first portion of the plurality of discs located between the first end of the frame and the axle, and a second portion of the plurality of discs located between the axle and the second end of the frame, wherein the first portion is aligned non-parallel with respect to the second portion; and
moving the frame relative to the hitch to pivot about the axle.

7. The method of claim 6, wherein moving the frame relative to the hitch to pivot about the axle includes actuating a hydraulic piston and cylinder assembly connected between the hitch and the frame.

8. The method of claim 6, wherein moving the frame relative to the hitch to pivot about the axle includes operating a hydraulic piston and cylinder assembly connected between the hitch assembly and the frame to adjust responsive to changes in terrain.

9. The method of claim 6, wherein supporting the frame on the soil via the axle includes supporting the frame on a plurality of wheels mounted on the axle.

10. The method of claim 6, wherein moving the frame relative to the hitch to pivot about the axle includes moving the frame relative to the hitch about a pivot between the frame and a base bar of the hitch.

11. The method of claim 10, further including actuating a hydraulic piston and cylinder assembly connected between the hitch and the frame to move the frame relative to the hitch about the pivot between the frame and the base bar of the hitch.

12. The method of claim 11, further including actuating the hydraulic piston and cylinder assembly by one of remotely controlling it via a controller and setting the hydraulic piston and cylinder assembly to automatically adjust in response to changes in terrain.

13. Apparatus for dividing soil, comprising:
a frame having a first bar and a second bar, wherein the first bar is located opposite to the second bar, wherein the frame has a first cross member and a second cross member connecting the first bar to the second bar, wherein the first cross member has a first length, wherein the second cross member has a second length, wherein the first length of the first cross member is greater than the second length of the second cross member;
an axle attached to the frame;
a cylinder connected to the frame and configured to be remotely controlled for movement to move the frame with respect to the soil, and where in the frame is configured to pivot at the axle; and
a vehicle connected to the frame and configured to pull the frame over the soil.

14. Apparatus for dividing soil, comprising:
a frame configured to be towed via a hitch at a first end of the frame,
an axle extending transversely of the frame and supporting the frame on the soil, the axle connected to the frame between the first end of the frame and a second end of the frame;
a plurality of rotatable discs configured to divide the soil and attached to the frame between the frame and the soil, a first portion of the plurality of discs located between the first end of the frame and the axle, and a second portion of the plurality of discs located between the axle and the second end of the frame, wherein the first portion is aligned non-parallel with respect to the second portion; and
wherein the frame is configured to move relative to the hitch to pivot about the axle.

15. The apparatus of claim 14, further including a hydraulic piston and cylinder assembly connected between the hitch and the frame and configured to move the frame relative to the hitch for pivoting the frame about the axle.

16. The apparatus of claim 15, wherein the hydraulic piston and cylinder assembly is configured to move responsive to changes in terrain to pivot the frame about the axle.

17. The apparatus of claim 14, further including a plurality of wheels mounted on the axle.

18. The apparatus of claim 14, further including a base bar on the hitch, and wherein the frame is pivotally connected to the base bar.

19. The apparatus of claim 18, further including a hydraulic piston and cylinder assembly connected between the hitch and the frame and configured to move the frame relative to the hitch about the pivotal connection to the base bar.

20. The apparatus of claim 19, wherein the hydraulic piston and cylinder assembly is configured to be actuated by one of remote control by a controller and automatic adjustment in response to changes in terrain.
